(19) United States
(12) Patent Application Publication
(10) Pub. No.: US 2009/0271321 A1
(43) Pub. Date: Oct. 29, 2009

(54) Method and system for verification of personal information

(76) Inventor: Grant Stafford, Bentleigh East (AU)

Correspondence Address: grant stafford, po box 101, central park, 3145, omitted

(21) Appl. No.: 12/302,911

(22) PCT Filed: May 31, 2007
(86) PCT No.: PCT/AU2007/000770

§ 371 Date: Dec. 1, 2008

(30) Foreign Application Priority Data
May 31, 2006 (AU) 2006100468
Jun. 13, 2006 (AU) 2006202519

(51) Int. Cl. H04L 9/32; G06Q 20/00; G06F 17/30; G06F 21/00

(52) U.S. Cl. 705/71; 705/76; 705/75; 707/104.1; 726/6; 713/168; 707/E17.044

(57) ABSTRACT

In one form, there is disclosed a system (100) for storing, validating and disseminating credential information about an entity. The system (100) generates data representing at least part of the credential information and a data representation of at least part of a document supporting that information and stores the credential information and data representation in a database (120) in an encrypted form.

### FIELD OF THE INVENTION

The present of invention relates to a system and method for providing validated credential information about an entity.

In a preferred form the present invention relates to systems and methods provided over a computer network for enabling the secure storage, transmission and authentication of validated credential information relating to an entity.

### BACKGROUND OF THE INVENTION

It is common for companies or government institutions to require credential information about entities with which they deal, and vice versa. Prior to engaging with such organisations a potential customer may need to go through an enrolment step in which such credentials are provided to the organisation. Physical documents may be required by the organisation in order to support various facts or characteristics supplied by the customer.

Current methods of authenticating personal or organisational credentials are typically wholly reliant on the performance, trust, and integrity of the employees tasked with authenticating new members' information and/or documentation. This reliance may allow an important point of failure in the trustworthiness of the system. The nature of data verification in such situations may be a matter of simply checking the form of data rather than verifying the informational content of data, eg as long as there is a number on the drivers license used for identification and as long as the name on the license matches a birth certificate or other second document then no question as to the authenticity of the documents and information is raised. Even if staff are diligent it is often difficult for them the determine the authenticity of a document meaning that at times a document's authenticity may be assumed, e.g. a document may appear to be a birth certificate issued by a foreign births registry and this fact is never questioned, where in reality the person checking the data has never seen or investigated what such a document should look like or contain.

The level of confidence which a recipient of information or a document can have in the information conveyed by that document relies on both the inbuilt security features of that document, such as watermarks etc and also the capability of that recipient to perform checks on the information content of the document.

Some forms of documentation provide a certain level of inbuilt security which enables their authenticity to be verified from the document alone, such as biometric passports and smart card based documents. However, there is a still a need for systems methods which will streamline the process of providing information relating to an entity to a third party, and for the third party in receiving and processing received data.

From the information owner's point of view, the need to constantly carry, store and show personal documents to third parties has drawbacks. For example, it can be seen as a privacy problem by the owner. Moreover, in the event that one of the documents is lost or stolen it is a costly and time consuming process to replace the document.

The possibility for fraud and lapses in security are further increased in situations where credential information is shared over a computer network such as the Internet. Therefore with the proliferation of online services, and online means of data collection being used by “bricks and mortar” organisations, there is a need for systems methods which enable information relating to an entity, such as an individual or business, to be securely shared across a computer network in a manner which ensures the security of the entity data and which also satisfies the recipient of the information that they have is authentic.

Moreover, a person may be required to repeatedly produce the same types of information to multiple bodies over a person's lifetime, which may be annoying.

### SUMMARY OF THE INVENTION

In a first aspect the present invention provides a method of compiling a credential database including: Receiving a document including credential information about an entity; Verifying at least part of the credential information included in the document; Generating data representing at least part of the credential information; Generating a data representation of at least part of the document; and Storing at least part of the credential information and data representation in a database in an encrypted form.

The method can further include storing identity data in respect of the entity in the database.

The method can further include storing a additional data in respect of the entity or credentials in the database.

The method can further include associating a financial account with the entity to enable transactions associated with the storage, processing or distribution of stored credential data relating to the entity to be processed.

Preferably the credential information and data representations stored in the encrypted form are able to be decrypted by or with permission of the entity to which the credential information and data representations relates.

The method can include repeating at least one of the steps of the method to add credential information about another entity to the database.

In a second aspect the present invention provides a method of providing credential data relating to an entity to a third party, the method including: Compiling a database of verified credential information associated with the entity; Receiving authorisation for the provision of said credential data to a third party, from or on behalf of the entity to which the credential data relates; Retrieving encrypted credential information to be released; Re-encrypting encrypted credential information for release; Providing the re-encrypted credential information to the third party.

The method can include, providing means for decrypting the re-encrypted credential information to either the third party or the entity.

The method can include, conducting a financial transaction with either or both of the third party or the entity in respect of the release of the credential information.

The database of verified credential information associated with the entity is preferably complied using a method according to the first aspect of the present invention.

The method can include, receiving a request for the provision of credential data from the third party.

The request can includes the means for decrypting the re-encrypted credential information that was provided to either the third party or the entity, or a data required to obtain said means from decrypting from another source.

The authorisation for the provision of said credential data to a third party can includes an indication which credential data is to be provided.

The method can further include associating a data release profile with an entity, which specifies one or more groups of credential date which may be released to a third party.

In a third aspect the present invention provides a system for providing credential information about an entity, the system including: a database storing, encrypted verified entity characteristic data relating to the entity, said verified entity data including, a representation of at least part of a document attesting to one or more characteristics of the entity, data representative of said one or more characteristics of the entity; and entity identification data associated with the encrypted verified entity characteristic data; first decryption means configured to decrypt at least part of the encrypted verified entity characteristic data upon receipt of a data staging request, the request including an entity identifier and corresponding decryption key; re-encryption means configured to re-encrypt the data decrypted by the first decryption means to generate encrypted releasable data; temporary storage means configured to store the encrypted releasable data, and associated decryption data, key signature, and entity identifier; transmission means to transmit at least the key signature to either one or both of the entity or the third party; second decryption means responsive to a received release request including an entity identifier and an associated key signature to decrypt the corresponding encrypted releasable data stored in the temporary storage means; and release means configured to release the decrypted data to the originator of the release request.

The system can which further include data selection means configured to determine which data is to be decrypted by the first decryption means on the basis of either or both of, a predetermined selection made by the entity or a selection associated.

In a further aspect the present invention provides a method of facilitating the verification of a characteristic of an entity including: providing access to a database storing, encrypted verified entity characteristic data relating to the entity, said verified entity data including, a representation of at least one document attesting to one or more characteristics of the entity, data representative of said one or more characteristics of the entity; and an entity identifier associated with the encrypted verified entity characteristic data; receiving a data staging request including an entity identifier and corresponding decryption key; decrypting at least part of the encrypted verified entity characteristic data using the received decryption key; re-encrypting the decrypted data to generate encrypted releasable data; temporarily storing the encrypted releasable data, an associated decryption data, key signature, and entity identifier; and transmitting at least the key signature to either one or both of the entity or a third party.

The method can further include: receiving a release request including an entity identifier and an associated key signature; decrypting encrypted releasable data stored in the temporary storage means that corresponds to the release request; and transmitting verified entity characteristic data relating to the entity to the originator of the release request.

The method can further include determining which data amongst the encrypted verified entity characteristic data relating to the entity is to be decrypted on the basis of either or both of, a predetermined selection made by the entity or a selection associated with the staging request.

### BRIEF DESCRIPTION OF THE DRAWINGS

Preferred forms of the present invention will now be described by way of non-limiting example only, with a reference to the accompanying drawings, in which:

FIG. 1 is a schematic representation of a system configured to implement an embodiment of the present invention;

FIG. 2 is a flow chart illustrating a process for preparing information for release to a third party in an embodiment of the present invention; and

FIG. 3 is a flow chart illustrating a method of transmitting released data to the third party in an embodiment of the present invention.

### DETAILED DESCRIPTION OF THE EMBODIMENTS

For convenience the following naming conventions will be used throughout the examples:
IdCheck_priv_key1—The system's private signing key
IdCheck_priv_key2—The system's private encryption key
IdCheck_pub_key1—The system's public signing key
IdCheck_pub_key2—The system's public encryption key
IdFiles—unencrypted credential information and/or associated documentation that has been verified as authentic and stored in Secure Zone 122.
IdInfo—Information provided to an information recipient (typically by an IdMember) and which is to be verified using the system.
IdMember—an entity that owns credential information stored in the system 100, e.g. IdMember may be a person, business, charity etc.
IdMember_digcert—IdMember digital certificate. i.e. Signed User_Pub_key1 by IdCheck_priv_key1
IdPad—encrypted one-time pad or symmetric key by User_priv_key1
IdPub—General public
IdSecFiles1—encrypted IdFiles by User_pub_key1.
IdSecFiles 2—encrypted IdFiles files. These files are encrypted with high quality symmetric algorithm e.g. One Time Pad
IdSecPad—encrypted one-timePad or symmetric key by User_priv_key1 and IdCheck_pub_key2
IdSig1 is a hash value of the IdPad i.e. OTP key which has been encrypted by User_priv_key1
IdSig2 is a hash value of IdSecPad i.e. OTP key which has been encrypted firstly by User_priv_key1 and secondly by IdCheck_pub_key2.
MIN—member identification number
PadKey1—one time pad key i.e. symmetric key
User_priv_key1—IdMember's private key
User_pub_key1—IdMember's public key

In the specification and claims the term “credential information” relates to any type of information relating to an entity, e.g. it can be data that can be used to identify the entity, or reflect certain characteristics it. For example, for a person, credential information can include, but is not limited to, basic identification information such as the persons, name, address, date or birth, as well other information such as their credit history, employment history, club memberships, educational history etc. For an organisation credential information can include, but is not limited to, a business name, address, company number, personal credential information relating to one or more employees etc.

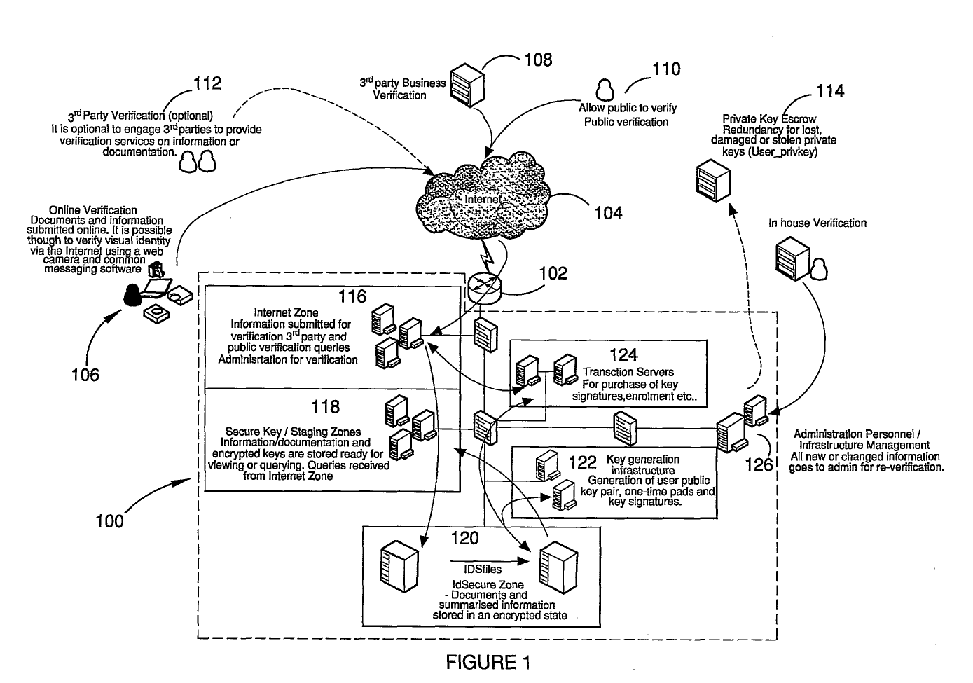

FIG. 1 illustrates a system 100 for storing, validating and disseminating credential information about an entity. The system 100 is connected via a firewall system and suitable network connection hardware such as a router 102 to a computer network such as the Internet 104. An entity client terminal 106 can communicate with the system 100 via the Internet 104 to store its credential information in the system and use the system to have that information disseminated to parties such as businesses 108 and individuals 110 who wish to receive their credential information. Optionally, the system 100 may be connected to additional third parties e.g. 112, to enable third party verification of credential information stored by the system 100. The system 100 can also be connected to other data storage services such as encryption key escrow systems 114 to enable secure storage of certain information outside the system 100.

The system 100 has several major subsystems that co-operate to store, verify and transmit credential information. Each of the main subsystems will now be described.

### Internet Zone (116)

The internet zone is effectively a web server for storing and hosting web pages and provides a web interface to the system that is accessible to external users. It handles all internet related interfacing tasks, such as the receipt of credential information for storage by the system 100, the receipt of credential information requests and the like.

### Secure Staging Zone (118)

The secure staging zone 118 is an area of the system 100 which includes a data store including a database of encrypted credential information which has been released by an entity for collection by an information user. The primary role of the staging zone is to store encrypted released information and security key data which is used during the data transmission process. The secondary role of the secure staging zone 118 is to store submitted information by the entity for the purposes of collection and verification of the system. Once an entity has been verified as authentic they are able to electronically submit information to the system for verification. The Secure Staging Zone servers interact with servers in the Internet Zone for the secure display, collection or release of credential information.

### Secure Zone (120)

The secure zone 120 includes a series of databases storing all credential information held by the system 100 and other associated data. All credential information stored in the secure zone 120 is encrypted by the IdMember's public key, which restricts access to the information to only the IdMember, as thus prevents unauthorised access to the credential information.

In the preferred embodiment, there are a plurality of data stores in the secure zone 120. In the illustrated example, the first data store IdSecureA holds encrypted information and IdSecureB holds released information or information that is about to be written to IdSecure A. (i.e. IdSecureB holds data coming from IdSecureA e.g. information approved for release to a third party, it also holds data going to IdSecureA, such as information representing newly verified credentials.) IdSecureA only communicates with other hosts in the secure zone 120. Information is put on IdSecureB first is to enable various automated checks to be run from IdSecureA before collection of the information, and because no other connection can be made to it from outside the secure zone.

### Key Generation Infrastructure (122)

The key generation infrastructure is used to manage the generation of encryption keys for use by the system 100.

### Transaction Servers (124)

The transaction servers 124 process financial transactions for the system 100. Typical transactions handled will include the purchase of key signatures and establishment of new accounts etc.

### Administration Sub-System (126)

The administration sub-system 126 is that portion of the system 100 which is used for performing administrative tasks on user accounts or data. For example, the administration sub-system 126 can be used to scan or upload hard copy documents into the system 100 i.e. to IdSecureB which then is moved to IdSecureA, or to perform tasks such as verification or modification of stored information.

Before an entity can use the system 100 for storing their credential information, the entity needs to open an account by enrolling with the system 100, i.e. it needs to become an IdMember.

As an initial step in the enrolment, the entity (eg an individual, business etc) submits their credential information or documentation to the system 100. Typically credential information and/or documentation will be initially supplied and verified manually for authenticity and integrity. The submission of this documentation can be either in person, over the Internet or via trusted partners such as postal outlets.

Verification of the information conveyed by the documentation can either be performed in a number of ways and may include; use of an Internet link with webcam for physical identification (e.g. that a person appears visually similar to a photograph), manual verification of individual documents, automated verification with third parties, or verification of document or data authenticity with a document's issuing body etc. The system may also have the facility to also allow the assignment of a ‘confidence’ rating against an entity that issues credentials. This rating can be used by recipients in their assessment of the weight to be given to an IdMembers' credential information. For example, the issuing body “Belford University” may verify that IdMember has a PhD, but if the system has a poor confidence rating for rate Belford University recipients may not trust the otherwise verified credentials? Or alternatively an IdMember user may choose not to release information to a recipient unless their confidence level is over a certain threshold set by either the system or the IdMember.

In some instances the IdMember can be allowed to set a preference on their account that any recipient of their sensitive data must be trusted by the system 100 e.g. by being pre-enrolled and with the system. i.e. the IdMember will only release credential information to other entities that share a certain level of trust with the system.

Once verified as authentic, information derived from a document or supplied by an entity is summarised into a separate text based object (such as XML or other form of computer readable or parseable data). The original documents are also electronically scanned and digitally signed and then encrypted before being archived within the Secure Zone. The summarized text based information is associated with the digitised copy of the documentation. This summarized information facilitates automated querying of the data by the system and use of the information by a recipient. An unencrypted electronic document and its accompanying summarized data in a system-compatible form, are referred to as IdFiles.

The encryption and submission process begins with the key generation infrastructure (122) generating an asymmetric or public key pair for the entity (User_pub_key1, User_priv_key1).

The system 100 then digitally signs IdFiles (e.g. text files and any associated digitized original documentation) with IDCheck_priv_key1 (system private key). The system creates a generic profile entity and populates this with information objects which reference encrypted profiles or documents/information of the entity. In the profile creation phase an entity is assigned a_member identification number (MIN) which should be unique to each entity. With this number they are able to access their verified information via the Internet (via a secure connection) along with submission of their private key and password(s). Optionally, a component could be installed on the entity's computer that enables the entity to verify the authenticity of its connection to the system 100 e.g. using IDmember digital certificate.

The system 100 then encrypts the entities information stored as IdFiles with User_pub_key1 to create IdSecFiles1 and submits encrypted information IdSecFiles1 for archiving in the secure zone 120. This method of encryption ensures that the entity that owns the data can decrypt their data (using User_priv_key1) and the system can verify the authenticity and integrity of the data being released due to its application of a digital signature to the data to be stored.

The entity's private key User_priv_key1 can optionally be given to the owner on a form of security pass, token, card, or key. This pass, token, card or key will store the private key in an encrypted state using a biometric such as a fingerprint or password. It will also contain IdMember_digcert which is a digital certificate provided by the system (as defined above i.e. signed member public key by system private key.) Moreover, the system may submit a copy of User_priv_key1 to an escrow service 114 at the choice of the IdMember. The public key User_pub_key1 is kept and used solely by the system for encrypting new documents or for secure communications between the system and the entity. The system then encrypts User_pub_key1 with IDCheck_pub_key2 to ensure only the system is able to communicate or encrypt data that purportedly belongs to the entity owning the key.

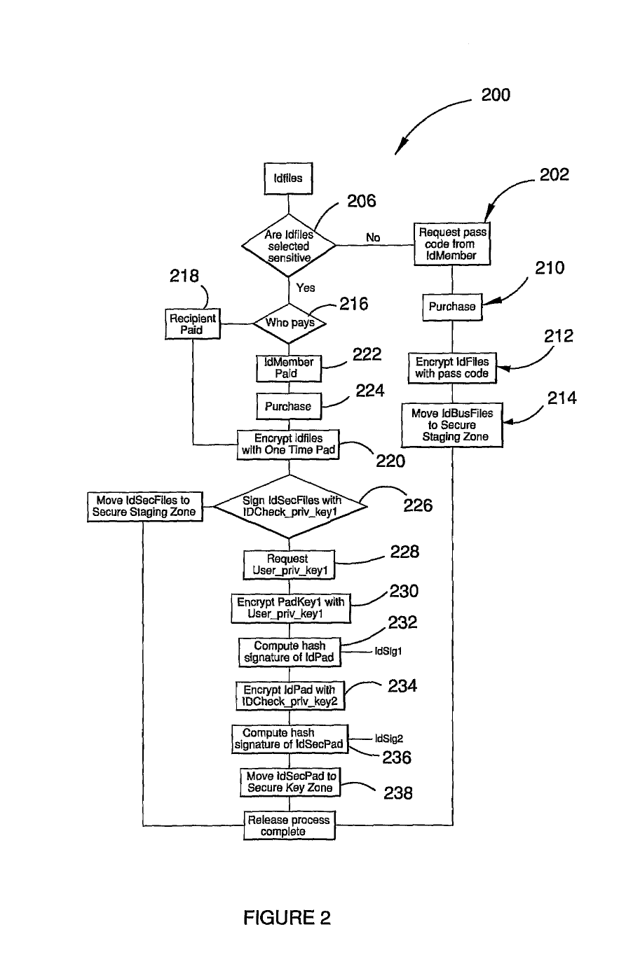

Once data representing a credential is encrypted and securely stored in the Secure Zone 120, if an entity wants to provide that data (or a chosen subset of it) to a third party, the information to be provided needs to be moved to the Secure Staging zone 118 to allow collection or transmission of the information. A process 200 for enabling release of the entities information to a recipient will now be described with reference to FIG. 2.

FIG. 2 shows a flowchart of a method of releasing credential information stored in the Secure zone (120) to a party (called the recipient).

In the exemplary embodiment, the system 100 has a web interface through which entities and recipients of data may interact with the system to store, administer, release and obtain verified credential data. To release data, in a first example the entity (IdMember) logs on to the website and elects to ‘release’ information using the appropriate interface. The IdMember can be presented with a listing of personal or sensitive information objects (e.g. a generic profile created earlier with a list of information objects and personal configurations or preferences of IdMember) from which he/she can select which data (or preselected set of data) to release. These objects reference items that are located within IdMember's personal information repository in the Secure Zone. Once selected the system locates IdSecFiles1 from IdSecureA using the MIN of the member and copies IdSecFiles1 to IdSecureB. In this example IDSecFiles1 include the whole encrypted set of member information or container of that information. At this stage the system requests for the member to submit their User_priv_key1 via a process explained previously. Information is decrypted by the system using the User_priv_key1 provided by the entity to generate unencrypted IdFiles. The selected information to be released is extracted from the IdFiles. These are then moved to the staging area, using the method 200 of FIG. 2. It should be noted that the information is only moved from IdSecureB to the staging zone once other processes such as key signature creation, decryption etc. have been completed. The remaining IdFiles are securely erased from IdSecureB thus leaving the original IdSecFiles1 on IdSecureA.

In most cases, the type of information that is to be released depends on the purpose eg different information will be released to enable the user to take out a bank loan, compared to buying a plane ticket. Information is stored by the system can be categorized into various levels of sensitivity. The more sensitive the information is to the entity, then the higher the sensitivity rating that can be applied to it. Preferably sensitive information can only be released securely, that is, it can only be released after confirmation by the entity as well as the generation (and purchase) of key signatures. Key signatures are a hash value or similarly secured (mathematical or computational summarisations) versions of encrypted passwords or one-time pads that enable the system to:
identify and locate information in the staging zone 118;
confirm that the information has been authorized for release by the entity;
detect whether any changes of information have occurred post-encryption; or
determine if key signatures have been paid for.

Advantageously, less sensitive information can be released via the use of a pass code. This allows IdMembers the ability to advertise various personal information of a less sensitive nature to the public (or other receiver) without the need to distribute key signatures. The use of a publicly available pass code (that may be made publicly available) provides a means for an unknown recipient eg member of the public, to check on the authenticity of information from an IdMember. Whilst providing access to selected items of the entities credential information the pass-code restricts the release of information—“to a certain level of confidence” to known recipients. There is nothing stopping a recipient of the passcode passing it on to others, however it is possible for the IdMember to restrict or otherwise contain the use or proliferation of the passcode to various recipients, such as by assigning a time-to-live to the pass code or a maximum number of uses to a given passcode. An IdMembers' member number and pass code can be used by the recipient to verify sensitive information classed as low sensitivity eg data ordinarily present on a business card. For instance, such a scheme could be used to authenticate a person that arrives at your door, e.g. to determine that the person presenting actually works for a particular company, are a registered doctor, a registered baby sitter, a builder, work for a particular charity and so on. These may be considered characteristics that should be readily available to the public. For this method of release, the credentials or information being released or advertised by the IdMember are limited to the immediate service, profession or otherwise have a low sensitivity or direct link to the IdMember

Information of a sensitive nature cannot be released by use of a pass code. The sensitivity of a piece of information may be able to be set by IdMember. However, in most cases the system will have predetermined sensitivities for some types of data, eg for example, the IdMembers date of birth, salary details, credit rating, tax file number, bank account numbers, credit card numbers etc., would all be considered highly sensitive information and as such classified to an appropriate sensitivity rating. Sensitive data is not able to be released without the purchase of key signatures. Typically key signatures are provided and released as a paid service. Advantageously, embodiments of a key signature purchase process involves multiple controls to ensure that the release of sensitive information is intentional, secure and ensures data is delivered to the intended recipient. (Certain controls are implemented to ensure situations of duress are accounted for i.e. to mimic the success of transactions or otherwise make the transaction with the system look authentic to the end user. In this situation the system sends appropriate alerts and provides the IdMember with inactive or unusable key signatures. This does not totally prevent the situation of release of sensitive information under duress but aims to assist.

An additional level of security that may be provided to IdMembers' is to ensure that the recipient of the personal information is authentic. In one embodiment of the release process IdMembers will be able to select from a set of recipients that have been ‘enrolled’ with the system. It is not a requirement that the recipient be listed within this set. Enrolment of a recipient involves the presentation of a digital certificate or other form of security device or tool by the recipient as part of the interaction with the system. If the recipient of a piece of information is another IdMember then it is possible to request their member digital certificate (IdMember_digcert). The certificate, device or tool will be checked during the ‘recipient authentication process’ to ensure that the actual recipient and intended recipient of the information are the same.

In a preferred form the key signature presentation provides significant confidence to the recipient that the information the key signature relates to is associated with the person presenting it. Similarly the person who is providing the key signature is most likely the person who created it. The system provides the ability to request as much identification and authentication as necessary to safeguard the transfer of sensitive information.

Turning now to the release process 200, this process begins with the IdMember selecting files or information for release. The IdMember can also be given the option of determining who pays for the service—the IdMember, or the recipient.

Generally speaking information to be released can be output in the following forms:

a) as a representation of an original verified document, eg in the form of scanned original documentation, digitally signed and stored in PDF or other format,
b) in a form containing only summarised information of the original documentation eg as plain text or advantageously in a compatible format such as XML.

All original files containing sensitive information are each digitally signed using IdCheck_priv_key1. Signatures are associated with each document or image.

Prior to any potentially sensitive action or process of data storing an entity's credential information, a message such as an email or webpage is generated which summarises the actions being taken by IdMember. This message requests approval for the sensitive action or process of data or release of the information. The message can be used to direct the IdMember eg using a web link embedded in an email, to a payment screen and then on to the rest of the release process.

Depending on whether the IdFiles being released to the recipient are sensitive or not, a different release process is used. For sensitive files, a highly secure symmetric or similar encryption process e.g. a one time pad, is used, whilst for non-sensitive files a pass code is used to secure documents before transmission to their recipient.

If the IdFiles that was selected by IdMember are non-sensitive and therefore only warrants that a pass code be created the release process follows the right hand branch of the flowchart illustrated in FIG. 2. For such data only summarized information will be released rather than copies of documents. In the examples shown in FIG. 2 the pass code release program begins with the system 100 requesting the user to select a pass code for releasing their selected credential information in step 208.

Next, payment for the pass code is processed. Typically, payment for the pass code will be made by the IdMember at this point rather than by the data recipient at the time of information collection. Although, the inverse process may be used if desired. The reason payment for a pass code is generally made by an IdMember is that it more closely aligns the idea behind the use of pass codes, namely to release less sensitive information of IdMember in a very convenient manner for use by the public. The IdMember can select how many times the passcode may be used or select to provide approval for every attempt at use of the passcode. The IdMember is charged appropriately depending on the use of such options.

Once the purchase of the pass code has been completed or a flag set to request payment for data before delivery, the IdFiles are symmetrically encrypted in step 212 using the pass code supplied by the IdMember.

Encrypted files are then moved to the secure staging zone 118 in step 214 and are then ready for collection by or transmission to the information recipient.

For sensitive documents and information, for which pass code security is deemed insufficient, the method begins in a similar manner, with a determination being made in step 216 of who pays for the transaction. If the recipient pays in step 218 the process moves straight to the step 220 in which the IdFiles are encrypted with a secure one time pad. On the other hand if the IdMember is going to pay for release of the data as indicated at 222 the purchase transaction is then processed at 224 prior to encryption of the IdFiles with the one time pad at step 220. In order to perform the encryption step 220 copies of the selected IdSecFiles1 are copied from IdSecure A (located in IdSecure Zone) to IdSecure B.

Following the process referred to earlier whereby the selected information to be released is identified from within IdSecFiles1, the unencrypted IdFiles (i.e. the information extracted from IdSecFiles1) are symmetrically encrypted using One Time Pad or similar highly secure algorithm that provides ‘perfect secrecy’, to create IdSecFiles2. The IdSecFiles2 are then digitally signed using IdCheck_priv_key1 and the signature is associated with the respective IdSecFiles2 in step 226. These encrypted IdSecFiles2 are moved to the Secure Staging Zone 118, under a directory associated with the MIN, to enable collection, or transmission to the recipient.

The key or pad (PadKey1) used for the One Time Pad is encrypted with User_priv_key1, requested in Step 228, to create IdPad in step 230.

Transmission of User_priv_key1 to the system 100 is conducted within an SSL or similar secure method e.g. (dual authenticated SSL, SSH or other secure protocol. If the key is stored on a token the User connects the token storage device (e.g. USB key with biometric and/or password access control) to their computer and a local control module (eg an ActiveX control) handles the capturing process of the User_priv_key1. The local control module encrypts User_priv_key1 with IdCheck_pub_key2 and transmits it to the system 100 where it is unencrypted with IdCheck_priv_key2.

Next, in step 232 a hash value of IdPad is created, called IdSig1. IdSig1 represents a first key signature component that is required by a recipient to collect/obtain the released information. IdMember can choose to either copy IdSig1 from the display or have it sent to him/herself in an email. If the email option is used, the system will encrypt IdSig1 with User_pub_key1 prior to sending.

A copy of IdSig1 is also sent to payment server for use in verifying that payment for the information release has been received. This will be verified and confirmed later as being paid for.

Next, IdPad is encrypted with IdCheck_pub_key2 to generate IdSecPad in step 234. A hash value of IdSecPad is created at 236, which is referred to as IdSig2, and is either displayed or sent to the IdMember in the same manner as IdSig1.

A directory is created inside the Secure Key Zone which is associated with the IdMember eg using his/her MIN, and IdSecPad is moved to Secure Key Zone in 238.

A directory is also created inside Secure Staging Zone which is also associated with the IdMember and IdSecFiles2 is moved from IdSecure B host, to Secure Staging Zone.

At this point in the release process, information that has been selected for release has been prepared for collection by the recipient/user of the information. In summary the following actions have occurred:
1 IdMember has received two key signatures IdSig1 and IdSig2. IdSig1 is a hash value of IdPad which has been encrypted by User_priv_key1. IdSig2 is a hash value of the IdSecPad
2 IdSecFiles2 have been moved to the Secure Staging zone
3 IdSecPad has been moved to the Secure Key Zone

Once information has been encrypted and stored in the staging area 118 a recipient of the information can make a request for that information. Depending on the type of information to be provided and the nature of the recipient the request process and data delivery process may vary. Three data release examples will now be provided to illustrate the versatility of the preferred embodiment. The first example illustrates an example applicable to, e.g. ecommerce related activities and relates to the release of Sensitive Information for a business recipient.

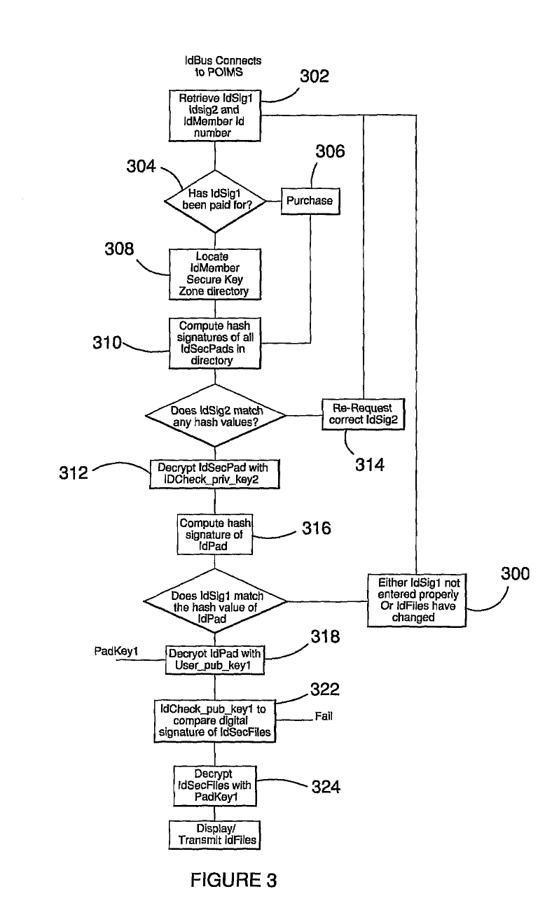

The first example, illustrated in FIG. 3, is applicable to situations such as when an IdMember (the entity) is using an online application form, such as an on-line loan application that might be available from a bank or other financial institution (the information user or recipient). In this case the member will be asked to enter certain application information into a form that is part of a website of the information user.

For convenience, the recipient of the information will be referred to as IdBus1.

As will be appreciated, the type of information required to be submitted and the level of information verification required by IdBus1 in order to provide the desired service or goods to the IdMember will depend on the nature of the service or goods.

Initially IdMember completes the requested form (either online or in person) and the information entered into the form or system of IdBus1 is extracted and put into a format parseable by IdBus1's systems (e.g. XML).

As IdBus1 will gather the same information in relation to different entities a large number of times, IdBus1 will typically establish standard verification protocols with the system 100, that enable data relating to certain predetermined credentials or characteristics of each IdMember to be verified.

Typically the data collected from the IdMember will be arranged according to the protocol with pre-defined tags which correspond to a standard set of required credential data, e.g. in the case of a bank the applicant's, name, tax file number, address, employment history, certain credit history data, etc. This is to allow IdBus1 systems to interface with the system 100 i.e. a common interface.

Along with the need to enter the required personal information input the IdMember will be asked to input their IdSig1, IdSig2 and their MIN.

IdBus1 then accesses the system 100, e.g. via a virtual private network or other secure means, such as using dual certificates or other (preferably “dual”) authenticated method.

IdBus1 transmits in step 302 a request for release of information from the IdMember's profile to the system 100. The request includes, IdSig1, IdSig2 and MIN. If the data being verified does not have predefined fields then the request may also specify the nature of the entity characteristic being checked.

The transaction subsystem 124 uses the MIN and IdSig1 to confirm payment for the release of the data has been made at 304.

If the recipient of the information, IdBus1, has to pay then payment may be completed in step 306 by either automatically adding an amount to IdBus1's account, or by manually stepping through a payment process e.g. using a conventional on-line credit card payment system. In the case where the IdMember has paid for the release of their credential information, then the transaction subsystem will look for a record of a pre-payment for the release or adding the release fee to the IdMember's account.

Once a payment has been verified the system 100, uses the IdMember's MIN to interrogate the data storage in the Secure Key Zone 120 at 308. The IdMember's directory in the Secure Key Zone 120 may include multiple IdSecPad's corresponding to different parcels of information authorized for release.

In step 310 the system 100 creates a hash against all IdSecPad's in the directory until a match against IdSig2 is found.

If IdSig2 is matched with an IdSecPad then the IdSecPad is decrypted using IdCheck_priv_key2 to retrieve IdPad in step 312. Otherwise a request for IdSig2 to be re-entered is made in step 314.

Next in step 316 a hash value of IdPad is created and compared with IdSig1. In the event that IdSig1 is a correct ‘hash’ of IdPad then User_pub_key1 which is securely stored by the system is retrieved and used by the system to decrypt IdPad at 318 to retrieve PadKey1.

In the event that IdSig does not match the hash value of IdPad one of two things can be determined to have occurred, either IdSig1 was not entered correctly or the IdPad has changed since the hash key signature was created. A request for re-entry of IdSig1 is made and the process retried. If the retry is unsuccessful the transmission of data is aborted. A set amount of attempts in the entries of IdSig1 and IdSig2 can be used to limit abuse of key signatures.

Next the system 100 sends PadKey1 to Secure Staging Zone servers 120.

The system then connects to the IdMember directory within the Secure Staging Zone 120 and computes hash values of the IdSecFiles2 stored therein in step 322. If the system computes a match between IdSecFiles2 and IdSig1 then IdCheck_pub_key1 is used to decrypt the digital signature and to compare the hash value of IdSecFiles2. Used IdSecPads or any other remaining files are removed from the system after use to prevent signature re-use.

Finally in step 324, PadKey1 is used to decrypt IdSecFiles2 to retrieve the IdFiles.

The decrypted and released IdFiles can then be transmitted or displayed to IdBus1 for use in the necessary data comparison and credential verification.

In an alternate scenario for communication with the system, IdBus1 could send IdInfo to the system 100 for comparison with the decrypted IdFiles. In this regard, if IdInfo matches IdFiles then IdBus1 can be assured that the information is verified, authentic, and that the person who is interacting with IdBus1 is more than likely the same person (IdMember) that produced IdSig1 and IdSig2, and that any other credentials supplied (and checked) are accurate and can be relied upon by IdBus1. (or otherwise provide a greater level of confidence as compared to traditional methods of identification verification or information authentication typically employed in commercial organisations.

IdBus1 can also verify integrity of IdFiles by using IdCheck_pub_key1 to decrypt the digital signature associated with IdFiles and by computing and comparing hash values.

A second data release and transmission example will now be given that is suited for use in low volume credential checking, and in which sensitive information is transmitted. For example the IdMember could be a business providing baby sitting services and the information to be released could be verified references or verified police checks relating to its babysitters. The information can be organized into a particular profiles for individuals, and contain a suite of relevant information about that person for release if needed. Similar applications may also apply to individuals or other entities that provides services to the public.

Another example could be a person wishing to apply to become a member of a video rental store. Such businesses will have an enrolment process in which prospective new members will need to provide identification of sufficient quality to satisfy the store that the new member is who they say they are, and that their address etc is correct. In this scenario the video store may request verification of supplied credentials from the system to increase their confidence in the supplied data.

In this case, because the IdMember is likely to be there in person and physically possess their documentation, an image of a document containing credentials, e.g. a drivers license, could be delivered by the system 100 and displayed to enable manual verification of the presented document (driver's license) in real-time.

Further text based credential information could also be displayed. As will be appreciated the classes of information relevant to such transactions may be limited, e.g. a person's medical history has nothing to do with a video rental store enrolment, and thus would not be made available to the information user, and then these types of information release scenarios lend themselves to the use of “release profiles” by the IdMember. These release profiles are created based on the ‘need to know’ principle.

In this case the IdMember provides the information recipient with their MIN and key signatures IdSig1 and IdSig2 that have been previously created in a release process, described above. The release may enable access to certain credential information, selected by the IdMember that is requested by the recipient and is relevant to the purpose of the release. As noted above an IdMember may have set predetermined credential profiles which they can used in such circumstances (for these purposes).

In this case, the recipient of the information, termed IdBus2 connects to the System, possibly via website interface and enters in the IdMember's MIN and the key signatures IdSig1 and IdSig2 that were created in the Release process described above. There is typically no requirement for IdBus2 to be enrolled or trusted by the system to complete this process.

From here the process is effectively the same as the previous embodiment, with IdSig1 and IdSig2 being used in the manner described in connection with FIG. 3 to decrypt the credential information released by the entity. If the release of the entities information has been paid for, then IdBus2 would have the predetermined data transmitted to or made available for viewing either original form and/or in summarized text (PDF) format. To the extent technically possible copies of data should not be allowed to be taken in a re-useable format. In a preferred embodiment, all released information is watermarked by the system and has a validity date associated. Certain IdMember information remains current only for a pre-determined set of time before it requires revalidation. Such information could include residential address as opposed to information relating to the IdMembers blood type or skin colour or birth records, which is information that generally does not change.

The final example relates to the release of credential information of a non-sensitive nature. For example, if an IdMember would like to advertise some of their credential information and provide a facility for members of the public to verify that information, they are able to create a “public profile” through which they are able to transmit files in an easier manner.

As a preliminary step a user needs to select credential information to be ‘transmitted’ to the public and then enter an associated pass code. The transaction server can be configured to require the IdMember to pay a fee to establish such a publicly accessible and verified credentials. The information protected by the pass code is stored in a generic profile store, unencrypted, on the Staging Servers 120 associated with the IdMember's MIN.

The IdMember's MIN and pass code can then be conveyed to the general public e.g. on a business card, email footer, job advertisements, pamphlet or the like to enable any member of the public to check the advertised credentials. The advantage of such an embodiment is that the credential data stored and released has been verified by the system 100 prior to release which increases the level of confidence that the recipient of the information can have in the authenticity of the information.

For example a professional such as an architect may list their qualifications and professional memberships on their business card, as well as their MIN and a passcode to enable clients or potential clients to check their credentials. The information could also be presented by tradespersons, or the like, when making house calls to verify that the person at the door is who they say they are e.g. Bob Brown from is an employee of Company X and is a certified architect by the Architects Association of Victoria etc.

The information could also be provided in resumes for verification of employment history.

In most embodiments a request for such information from a member of the public will come via a web interface of the system 100.

This form of ‘release’ is not as secure as the previous embodiments, since data can be transmitted multiple times.

It will be understood that the invention disclosed and defined in this specification extends to all alternative combinations of two or more of the individual features mentioned or evident from the text or drawings. All of these different combinations constitute various alternative aspects of the invention.

1. A method of compiling a credential database including:
Receiving a document including credential information about an entity;
Verifying at least part of the credential information included in the document;
Generating data representing at least part of the credential information;
Generating a data representation of at least part of the document; and
Storing at least part of the credential information and data representation in a database in an encrypted form.

2. The method of claim 1 which further includes;
Storing identity data in respect of the entity in the database.

3. The method of claim either of claims 1 or 2 which further includes;
Storing a additional data in respect of the entity or credentials in the database.

4. The method of any one of claims 1 to 3 which further includes;
Associating a financial account with the entity to enable transactions associated with the storage, processing or distribution of stored credential data relating to the entity to be processed.

5. A method of providing credential data relating to an entity to a third party, the method including:
Compiling a database of verified credential information associated with the entity;
Receiving authorisation for the provision of said credential data to a third party, from or on behalf of the entity to which the credential data relates;
Retrieving encrypted credential information to be released;
Re-encrypting encrypted credential information for release;
Providing the re-encrypted credential information to the third party.

6. The method of claim 5 which further includes:
Providing means for decrypting the re-encrypted credential information to either the third party or the entity.

7. The method of claim 5 which further includes, conducting a financial transaction with either or both of the third party or the entity in respect of the release of the credential information.

8. A method as claimed in any one of claims 5 to 7 wherein the database of verified credential information associated with the entity is complied using a method as claimed in any one of claims 1 to 4.

9. A method as claimed in any one of claims 5 to 8 which further includes a step of:
receiving a request for the provision of credential data from the third party.

10. A method as claimed in any one of claims 5 to 8 wherein the authorisation for the provision of said credential data to a third party includes an indication which credential data is to be provided.

11. The method of any one of claims 1 to 4 which further includes associating a data release profile with an entity, which specifies one or more groups of credential date which may be released to a third party.

12. A system for providing credential information about an entity, the system including:
a database storing, encrypted verified entity characteristic data relating to the entity, said verified entity data including, a representation of at least part of a document attesting to one or more characteristics of the entity, data representative of said one or more characteristics of the entity; and entity identification data associated with the encrypted verified entity characteristic data;
first decryption means configured to decrypt at least part of the encrypted verified entity characteristic data upon receipt of a data staging request, the request including an entity identifier and corresponding decryption key;
re-encryption means configured to re-encrypt the data decrypted by the first decryption means to generate encrypted releasable data;
temporary storage means configured to store the encrypted releasable data, and associated decryption data, key signature, and entity identifier;
transmission means to transmit at least the key signature to either one or both of the entity or the third party;
second decryption means responsive to a received release request including an entity identifier and an associated key signature to decrypt the corresponding encrypted releasable data stored in the temporary storage means; and
release means configured to release the decrypted data to the originator of the release request.

13. The system of claim 12 which further includes data selection means configured to determine which data is to be decrypted by the first decryption means on the basis of either or both of, a predetermined selection made by the entity or a selection associated

14. A method of facilitating the verification of a characteristic of an entity including:
providing access to a database storing, encrypted verified entity characteristic data relating to the entity, said verified entity data including, a representation of at least one document attesting to one or more characteristics of the entity, data representative of said one or more characteristics of the entity; and an entity identifier associated with the encrypted verified entity characteristic data;
receiving a data staging request including an entity identifier and corresponding decryption key;
decrypting at least part of the encrypted verified entity characteristic data using the received decryption key;
re-encrypting the decrypted data to generate encrypted releasable data;
temporarily storing the encrypted releasable data, an associated decryption data, key signature, and entity identifier; and
transmitting at least the key signature to either one or both of the entity or a third party.

15. The method of claim 14 which further includes:
receiving a release request including an entity identifier and an associated key signature;
decrypting encrypted releasable data stored in the temporary storage means that corresponds to the release request; and
transmitting verified entity characteristic data relating to the entity to the originator of the release request.

16. The method of either of claims 14 or 15 further including:
determining which data amongst the encrypted verified entity characteristic data relating to the entity is to be decrypted on the basis of either or both of, a predetermined selection made by the entity or a selection associated with the staging request.

17. The method of any one of claims 1 to 4 wherein the credential information and data representations stored in the encrypted form are able to be decrypted by or with permission of the entity to which the credential information and data representations relates.

18. The method of any one of claims 1 to 4 wherein the method includes repeating at least one of the steps of the method to add credential information about another entity to the database.

19. A method as claimed in claim 9 wherein the request includes the means for decrypting the re-encrypted credential information that was provided to either the third party or the entity, or a data required to obtain said means from decrypting from another source.
